(19) United States
(12) Patent Application Publication
(10) Pub. No.: US 2022/0194814 A1
(43) Pub. Date: Jun. 23, 2022

(54) PROCESS FOR PRECIPITATING A MIXED HYDROXIDE, AND CATHODE ACTIVE MATERIALS MADE FROM SUCH HYDROXIDE

(71) Applicant: BASF SE, Ludwigshafen am Rhein (DE)

(72) Inventors: Thorsten BEIERLING, Ludwigshafen (DE); Simon SCHROEDLE, Tokyo (JP); James SIOSS, Beachwood, OH (US); Daniela PFISTER, Ludwigshafen (DE); KALO Benedikt, Battle Creek, MI (US); Christoph ERK, Ludwigshafen (DE); Brandon LONG, Macedonia, OH (US); Christian RIEMANN, Ludwigshafen (DE); Christine AMMONS, Beachwood, OH (US); Yohko TOMOTA, Ludwigshafen (DE); Phil Jack HOLZMEISTER, Ludwigshafen (DE)

(21) Appl. No.: 17/594,006

(22) PCT Filed: Apr. 2, 2020
(86) PCT No.: PCT/EP2020/059419

§ 371 Date: Sep. 30, 2021

(30) Foreign Application Priority Data
Apr. 10, 2019 (EP) 19168300.2
Mar. 30, 2020 (EP) 20166783.9

(51) Int. Cl. C01G 53/00; B01J 19/18; H01M 4/525; H01M 4/505; H01M 10/0525

(52) U.S. Cl. CPC C01G 53/50; B01J 19/18; H01M 4/525; H01M 4/505; H01M 10/0525; C01P 2006/12; H01M 2004/028; C01P 2004/03; C01P 2004/51; C01P 2006/40; C01P 2004/50; B01J 2219/00164; C01P 2006/14

(57) ABSTRACT

Process for precipitating a mixed hydroxide of TM wherein TM comprises Ni and at least one of Co and Mn and, optionally, Al, Mg, Zr or Ti, from an aqueous solution of salts of such transition metals or of Al or of Mg, wherein such process is carried out in a stirred vessel and comprises the step of introducing an aqueous solution of alkali metal hydroxide and an aqueous solution of transition metal salts through at least two inlets into said stirred vessel wherein the distance of the locations of introduction of salts of TM and of alkali metal hydroxide is equal or less than 6 times the hydraulic diameter of the tip of the inlet pipe of the alkali metal hydroxide.

The present invention is directed towards a process for precipitating a mixed hydroxide of TM wherein TM comprises Ni and at least one of Co and Mn and, optionally, Al, Mg, Zr or Ti from an aqueous solution of salts of such transition metals or of Al or of Mg, wherein such process is carried out in a stirred vessel and comprises the step of introducing an aqueous solution of alkali metal hydroxide and an aqueous solution of transition metal salts through at least two inlets into said stirred vessel wherein the distance of the locations of introduction of salts of TM and of alkali metal hydroxide is equal or less than 6 times, preferably equal or less than 4 times the hydraulic diameter of the tip of the inlet pipe of the alkali metal hydroxide.

Lithium ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed the solutions found so far still leave room for improvement.

The electrode material is of crucial importance for the properties of a lithium ion battery. Lithium-containing mixed transition metal oxides have gained particular significance, for example spinels and mixed oxides of layered structure, especially lithium-containing mixed oxides of nickel, manganese and cobalt; see, for example, EP 1 189 296. However, not only the stoichiometry of the electrode material is important, but also other properties such as morphology and surface properties.

Corresponding mixed oxides are prepared generally using a two-stage process. In a first stage, a sparingly soluble salt of the transition metal(s) is prepared by precipitating it from a solution, for example a carbonate or a hydroxide. This sparingly soluble salt is in many cases also referred to as a precursor. In a second stage, the precipitated salt of the transition metal(s) is mixed with a lithium compound, for example Li₂CO₃, LiOH or Li₂O, and calcined at high temperatures, for example at 600 to 1100° C.

Existing lithium ion batteries still have potential for improvement, especially with regard to the energy density. For this purpose, the cathode material should have a high specific capacity. It is also advantageous when the cathode material can be processed in a simple manner to give electrode layers of thickness from 20 μm to 200 μm, which should have a high density in order to achieve a maximum energy density (per unit volume), and a high cycling stability.

In WO 2012/095381 and WO 2013/117508, processes for the precipitation of hydroxides or carbonates are disclosed wherein vessels with compartments are used. A lot of energy is introduced in the respective compartment(s). Carrying out said process on commercial scale is difficult, though.

It was an objective of the present invention to provide a process for making precursors of cathode active materials for lithium ion batteries which have a high volumetric energy density and excellent cycling stability. More particularly, it was therefore an objective of the present invention to provide starting materials for batteries which are suitable for producing lithium ion batteries with a high volumetric energy density and excellent cycling stability. It was a further objective of the present invention to provide a process by which suitable starting materials for lithium ion batteries can be prepared.

Without wishing to be bound to any theory, it can be assumed that the lithiation process is depending on the particle diameter, porosity and specific surface area of a precursor. It was an objective of the present invention to provide a process for making precursors which can be lithiated in a very efficient way. More particularly, it was therefore an objective of the present invention to provide starting materials for batteries which can be lithiated in a very efficient way.

Accordingly, the process defined at the outset has been found, hereinafter also referred to as inventive process or process according to the (present) invention. The inventive process may be carried out as a batch process or as a continuous or semi-continuous process. Preferred are continuous processes.

The inventive process is a process for precipitating a mixed hydroxide of TM. In the context of the present invention, “mixed hydroxides” refer to hydroxides and do not only include stoichiometrically pure hydroxides but especially also compounds which, as well as transition metal cations and hydroxide ions, also have anions other than hydroxide ions, for example oxide ions and carbonate ions, or anions stemming from the transition metal starting material, for example acetate or nitrate and especially sulfate.

In one embodiment of the present invention, mixed hydroxides may have 0.01 to 45 mole-% and preferably 0.1 to 40 mole-% of anions other than hydroxide ions, based on the total number of anions of said mixed hydroxide. Sulfate may also be present as an impurity in embodiments in which a sulfate was used as starting material, for example in a percentage of 0.001 to 1 mole %, preferably 0.01 to 0.5 mole-%.

In the context of the present invention, TM comprises Ni and at least one of Co and Mn and, optionally, Al, Mg, Zr or Ti. Preferably, TM is selected from the group consisting of Ni and at least one of Co and Mn and, optionally, Al, Mg, Zr or Ti. Although Al and Mg are not transition metals, in the context of the present invention, solutions of salts of TM are hereinafter also referred to as solutions of transition metals.

In one embodiment of the present invention, TM contains metals according to the general formula (I)

NiₐM¹_{b}Mn_{c} (I)

where the variables are each defined as follows:
M¹ is Co or combinations of Co and at least one element selected from Ti, Zr, Al and Mg,
a is in the range from 0.15 to 0.95, preferably 0.5 to 0.9,
b is in the range from zero to 0.35, preferably 0.03 to 0.2,
c is in the range from zero to 0.8, preferably 0.05 to 0.65,
   where a+b+c=1.0, and at least one of b and c is greater than zero.

In embodiments wherein M¹ is of Co and at least one element selected from Ti, Zr, Al and Mg, it is preferred that at least 95 mole-% up to 99.9 mole-% of M¹ is Co.

In one embodiment of the present invention, the variables in formula (I) are defined as follows:
a is in the range of from 0.8 to 0.95,
M¹ is a combination of Co and at least one element selected from Ti, Zr, Al and Mg, with 95 mole-% up to 99.9 mole-% of M¹ being Co,
b is in the range of from 0.03 to 0.2,
c is zero,
   and a+b+c=1.0.

In another embodiment of the present invention, the variables in formula (I) are defined as follows:
a is in the range of from 0.6 to 0.95,
M¹ is Co or a combination of Co and at least one element selected from Ti, Zr, Al and Mg, with 95 mole-% up to 99.9 mole-% of M¹ being Co,
b is in the range of from 0.03 to 0.2,
c is in the range of from 0.05 to 0.2,
   and a+b+c=1.0.

In another embodiment of the present invention, the variables in formula (I) are defined as follows:
a is in the range of from 0.15 to 0.5,
b is zero to 0.05,
c is in the range of from 0.55 to 0.8,
   and a+b+c=1.0.

Many elements are ubiquitous. For example, sodium, copper and chloride are detectable in certain very small proportions in virtually all inorganic materials. In the context of the present invention, proportions of less than 0.02 mole % of cations or anions are disregarded. Any mixed hydroxide obtained according to the inventive process which comprises less than 0.02 mole % of sodium is thus considered to be sodium-free in the context of the present invention.

In one embodiment of the present invention the inventive process is a process for precipitating a mixed hydroxide with an average particle diameter (D50) in the range of from 2 to 20 μm, preferably 2 to 16 μm, more preferably 9 to 16 μm, determined by LASER diffraction.

The inventive process is carried out in a stirred vessel. Said stirred vessel may be a stirred tank reactor or a continuous stirred tank reactor. Said continuous stirred tank reactor may be selected from stirred tank reactors that constitute a part of a cascade of stirred tank reactors, for example a cascade of two or more, particularly two or three stirred tank reactors.

In the course of the inventive process, an aqueous solution of alkali metal hydroxide and an aqueous solution of transition metals is introduced into said stirred vessel.

In the context of the present invention, aqueous solution of nickel and one of manganese and cobalt and—optionally—at least one more cation such as Al³⁺ or Mg²⁺ is also referred to as aqueous solution of transition metals salts for short.

Aqueous solution transition of metal salts comprises a nickel salt and a cobalt salt and/or a manganese salt. Preferred examples of nickel salts are especially water-soluble nickel salts, i.e. nickel salts which have a solubility of at least 25 g/l and preferably 50 g/l, in distilled water, determined at 20° C. Preferred salts of nickel, cobalt and manganese are in each case, for example, salts of carboxylic salts, especially acetates, and also sulfates, nitrates, halides, especially bromides or chlorides, of nickel, cobalt and manganese, the nickel being present as Ni⁺², the cobalt being present as Co⁺², and the manganese being present as Mn⁺². However, Ti and/or Zr, if applicable, are present in an oxidation state of +4. Aluminum is present in the oxidation sate of +3, and it may be introduced, e.g., as sodium aluminate or as acetate or sulfate of aluminum.

Aqueous solution of transition metal salts may comprise at least one further transition metal salt, preferably two or three further transition metal salts, especially salts of two or three transition metals or of cobalt and aluminum. Suitable transition metal salts are especially water-soluble salts of transition metal(s), i.e. salts which have a solubility of at least 25 g/l, preferably 50 g/l in distilled water, determined at room 20° C. Preferred transition metal salts, especially salts of cobalt and manganese, are, for example, carboxylic acid salts, especially acetates, and also sulfates, nitrates, halides, especially bromides or chlorides, of transition metal, the transition metal(s) preferably being present in the +2 oxidation state. Such a solution preferably has a pH value in the range from 1 to 5, more preferably in the range from 2 to 4.

In one embodiment of the present invention, it is possible to proceed from an aqueous solution of transition metal salts which comprises, as well as water, one or more organic solvents, for example ethanol, methanol or isopropanol, for example up to 15% by volume, based on water. Another embodiment of the present invention proceeds from an aqueous solution of transition metal salts comprising less than 0.1% by weight, based on water, or preferably no organic solvent.

In one embodiment of the present invention, aqueous solution of transition metal salts used comprises ammonia, ammonium salt or one or more organic amines, for example methylamine or ethylene diamine. Aqueous solution of transition metal salts preferably comprises less than 10 mol % of ammonia or organic amine, based on transition metal M. In a particularly preferred embodiment of the present invention, aqueous solution of transition metal salts does not comprise measurable proportions of either of ammonia or of organic amine.

Preferred ammonium salts may, for example, be ammonium sulfate and ammonium sulfite.

Aqueous solution of transition metal salts may, for example, have an overall concentration of transition metal(s) in the range from 0.01 to 4 mol/l of solution, preferably 1 to 3 mol/l of solution.

In one embodiment of the present invention, the molar ratio of transition metals in aqueous solution of transition metal salts is adjusted to the desired stoichiometry in the cathode material or mixed transition metal oxide to be used as precursor. It may be necessary to take into account the fact that the solubility of different transition metal carbonates can be different.

Aqueous solution of transition metal salts may comprise, as well as the counterions of the transition metal salts, one or more further salts. These are preferably those salts which do not form sparingly soluble salts with M, or bicarbonates of, for example, sodium, potassium, magnesium or calcium, which can cause precipitation of carbonates in the event of pH alteration. One example of such salts is ammonium sulfate.

In another embodiment of the present invention, aqueous solution of transition metal salts does not comprise any further salts.

In one embodiment of the present invention, aqueous solution of transition metal salts may comprise one or more additives which may be selected from biocides, complexing agents, for example ammonia, chelating agents, surfactants, reducing agents, carboxylic acids and buffers. In another embodiment of the present invention, aqueous solution of transition metal salts does not comprise any additives.

Examples of suitable reducing agents which may be in aqueous solution of transition metal salts are sulfites, especially sodium sulfite, sodium bisulfite (NaHSO₃), potassium sulfite, potassium bisulfite, ammonium sulfite, and also hydrazine and salts of hydrazine, for example the hydrogen sulfate of hydrazine, and also water-soluble organic reducing agents, for example ascorbic acid or aldehydes.

Alkali metal hydroxides may be selected from hydroxides of lithium, rubidium, cesium, potassium and sodium and combinations of at least two of the foregoing, preferred are potassium and sodium and combinations of the foregoing, and more preferred is sodium.

Aqueous solution of alkali metal hydroxide may have a concentration of hydroxide in the range from 0.1 to 12 mol/l, preferably 6 to 10 mol/l.

Aqueous solution of alkali metal hydroxide used in the inventive process may comprise one or more further salts, for example ammonium salts, especially ammonium hydroxide, ammonium sulfate or ammonium sulfite. In one embodiment, a molar NH₃: transition metal ratio of 0.01 to 0.9 and more preferably of 0.05 to 0.65 can be established.

In one embodiment of the present invention, aqueous solution of alkali metal hydroxide may comprise ammonia or one or more organic amines, for example methylamine. It is preferred that no measurable amounts of organic amine are present.

In one embodiment of the present invention, aqueous solution of alkali metal hydroxide may comprise some carbonate or hydrogen carbonate. Technical grade potassium hydroxide usually contains some potassium (bi)carbonate, and technical grade of sodium hydroxide usually contains some sodium (bi)carbonate. Despite such content of alkali metal (bi)carbonate, in the context of the present invention the respective technical grade alkali metal hydroxide is referred to as alkali metal hydroxide for short.

The inventive process is carried out in a stirred vessel and includes carrying out the inventive process in a stirred tank reactor or in a continuous stirred tank reactor or in a cascade of at least two continuous stirred tank reactors, for example in a cascade of 2 to 4 continuous stirred tank reactors. It is preferred to carry out the inventive process in a continuous stirred tank reactor.

Continuous stirred tank reactors contain at least one overflow system that allows to continuously—or within intervals—withdraw slurry from said continuous stirred tank reactor.

The inventive process comprises the step of introducing an aqueous solution of alkali metal hydroxide and an aqueous solution of transition metal salts through at least two inlets into said stirred vessel wherein the distance of the locations of introduction of transition metal salts and of alkali metal hydroxide is equal or less than 6 times the hydraulic diameter of the tip of the inlet pipe of the alkali metal hydroxide, preferably equal or less than 4 times and even more preferably equal or less than 2 times. This step is also referred to as “introduction step”.

In the context of the present invention, the expression “tip of an inlet” refers to the location where solution of alkali metal hydroxide or of transition metals leaves the respective inlet.

The hydraulic diameter is defined as the four-fold of the cross-sectional area of the inlet tip divided b<y the wetted parameter of the inlet tip.

In one embodiment of the present invention, aqueous solution of alkali metal hydroxide and aqueous solution of transition metal salts are introduced into said stirred vessel through two inlets, e.g., two pipes whose outlets are located next to each other, for example in parallel, or through a Y-mixer.

In a preferred embodiment of the present invention, at least two inlets are designed as a coaxial mixer that comprises two coaxially arranged pipes through which an aqueous solution of alkali metal hydroxide and an aqueous solution of transition metal salts are introduced into a stirred vessel. In one embodiment of the present invention, the introduction step is carried out by using two or more coaxially arranged pipes through which an aqueous solution of alkali metal hydroxide and an aqueous solution of transition metal salts are introduced into said stirred vessel. In another embodiment of the present invention, the introduction step is carried out by using exactly one system of coaxially arranged pipes through which an aqueous solution of alkali metal hydroxide and an aqueous solution of transition metal salts are introduced into said stirred vessel.

Even more preferably, the aqueous solution of alkali metal hydroxide and the aqueous solution of transition metal salts are introduced through two inlets into said stirred vessel wherein said two inlets are designed as a coaxial mixer.

Although it is possible that some shares of aqueous solution of alkali metal hydroxide and of aqueous solution of transition metal salts are introduced at different locations as well, for example up to 30% of aqueous solution of alkali metal hydroxide and up to 30% of aqueous solution of transition metal salts, it is preferred that all aqueous solution of alkali metal hydroxide and of aqueous solution of transition metal salts are introduced through the above arrangement of pipes.

In one embodiment of the present invention, the locations of the introduction of the aqueous solutions of transition metal salts and of alkali metal hydroxide are below the level of liquid in the stirred vessel. In another embodiment of the present invention, the locations of the introduction of the aqueous solutions of transition metal salts and of alkali metal hydroxide are above the level of liquid in the stirred vessel.

In the course of said preferred embodiment of the introduction step, said aqueous solution of alkali metal hydroxide may be introduced through one pipe of a coaxially mixer and said solution of transition metal salts is introduced through the other pipe of said coaxially arranged pipes.

In one embodiment of the present invention, the velocity for introducing aqueous solution of alkali metal hydroxide and aqueous solution of transition metal salts is in the range of from 0.01 to 10 m/s. On large scale, for example in a stirred vessel of 10 m³ or more, velocities of 0.5 to 5 m/s are preferred.

In a preferred embodiment of the present invention, the aqueous solution of transition metal salts is introduced through the inner pipe of a coaxial mixer and the aqueous solution of alkali metal hydroxide is introduced through the outer pipe, this will lead to a minor degree of incrustations.

In one embodiment of the present invention, the inner pipe of said coaxial mixer has an inner diameter in the range of from 1 mm to 120 mm, preferred in the range from 5 mm to 50 mm, depending on the vessel size. The bigger the vessel, the bigger the diameter of the inlet tip.

In one embodiment of the present invention, the outer pipe of the coaxial mixer has an inner diameter in the range of from 1.5 to 10 times the inner diameter of the inner pipe, preferred 1.5 to 6 times.

Said pipes preferably have a circular profile.

In one embodiment of the present invention, the walls of the pipes have a thickness in the range of from 1 to 10 mm.

Said pipes may be made from steel, stainless steel, or from steel coated with PTFE (polytetrafluoroethylene), FEP (fluorinated ethylene-propylene copolymer), or PFA (perfluoroalkoxy polymer), preference being given to stainless steel.

In one embodiment of the present invention, the pipes of the coaxial mixer are bent. In a preferred embodiment of the present invention, the pipes of the coaxial mixer are non-bent.

Said coaxial mixer may serve as coaxial nozzle.

In one embodiment of the present invention locations of the introduction of the aqueous solutions of transition metal salts and of alkali metal hydroxide are above the level of liquid, for example by 3 to 50 cm. In a preferred embodiment of the present invention, the locations of the introduction of the aqueous solutions of transition metal salts and of alkali metal hydroxide are below the level of liquid, for example by 5 to 30 cm, preferably larger than 10 cm up to 20 cm.

In one embodiment of the present invention the pH value at the point of the outlet of said at least two inlets is in the range of from 11 to 15, preferably from 12 to 14.

In one embodiment of the present invention the tips of said at least two inlets are outside of a vortex caused by the stirring in the stirred vessel.

In various embodiments, especially when the turbulence at the outlet of the at least two inlets is too low, precipitates of mixed metal (oxy)hydroxide form at the outlet of a coaxial mixer, and they may form incrustations. In a preferred embodiment of the present invention, in certain time intervals, the at least two inlets and preferably the coaxial mixer is flushed with water to physically remove transition metal (oxy)hydroxide incrustations. Said intervals may occur, for example, every 2 minutes up to every other hour, and said flushing period may last in the range of from 1 second to five minutes, preferably 1 to 30 seconds. Flushing intervals as short as possible are preferred in order to avoid unnecessary dilution of the reaction medium. In one embodiment of the present invention, said water may contain ammonia to maintain the pH value above 7.

In one embodiment of the present invention, said stirred vessel is charged with water or an aqueous solution of ammonia, an ammonium salt or an alkali metal salt before commencement of the introduction step. In a preferred embodiment of the present invention, said stirred vessel is charged with an aqueous medium containing at least one of the foregoing ingredients and having a pH value in the range of from 10 to 13.

The stirred vessel described above may additionally include one or more pumps, inserts, mixing units, baffles, wet grinders, homogenizers and stirred tanks working as a further compartment in which the precipitation takes place and preferably having a much smaller volume than the vessel described at the outset. Examples of particularly suitable pumps are centrifugal pumps and peripheral wheel pumps.

In a preferred embodiment of the present invention, though, such stirred vessel is void of any separate compartments, external loops or additional pumps.

In one embodiment of the present invention, the process according to the invention can be performed at a temperature in the range from 20 to 90° C., preferably 30 to 80° C. and more preferably 35 to 75° C. The temperature is determined in the stirred vessel.

The process according to the invention can be performed under air, under inert gas atmosphere, for example under noble gas or nitrogen atmosphere, or under reducing gas atmosphere. Examples of reducing gases include, for example, CO and SO₂. Preference is given to working under inert gas atmosphere.

In one embodiment of the present invention, aqueous solution of transition metals and aqueous solution of alkali metal hydroxide have a temperature in the range of 10 to 75° C. before they are contacted in stirred vessel.

The stirred vessel comprises a stirrer. Suitable stirrers may be selected from pitch blade turbines, Rushton turbines, cross-arm stirrers, dissolver blades and propeller stirrers. Stirrers may be operated at rotation speeds that lead to an average energy input in the range from 0.1 to 10 W/l, preferably in the range from 1 to 7 W/l.

In embodiments wherein the stirred vessel is a continuous stirred tank reactor or a cascade of at least two stirred tank reactors, the respective stirred tank reactor(s) have an overflow system. Slurry containing precipitated mixed metal hydroxide of TM and a mother liquor. In the context of the present invention, mother liquor comprises water-soluble salts and optionally further additives present in solution. Examples of possible water-soluble salts include alkali metal salts of the counterions of transition metal, for example sodium acetate, potassium acetate, sodium sulfate, potassium sulfate, sodium nitrate, potassium nitrate, sodium halide, potassium halide, including the corresponding ammonium salts, for example ammonium nitrate, ammonium sulfate and/or ammonium halide. Mother liquor most preferably comprises sodium sulfate and ammonium sulfate and ammonia.

In one embodiment of the present invention, the inventive process is performed in a vessel that is equipped with a clarifier. In a clarifier, mother liquor is separated from precipitated mixed metal hydroxide of TM and the mother liquor is withdrawn.

By performing the inventive process, an aqueous slurry is formed. From said aqueous slurry, a particulate mixed hydroxide may be obtained by solid-liquid separation steps, for example filtering, spray-drying, drying under inert gas or air, or the like. If dried under air, a partial oxidation may take place, and a mixed oxyhydroxide of TM is obtained.

Precursors obtained according to the inventive process are excellent starting materials for cathode active materials which are suitable for producing batteries with a maximum volumetric energy density.

We have observed that by performing the inventive process it is possible to run the coprecipitation at nickel and manganese concentrations in the bulk which lead to an accumulation of Ni simultaneously in larger secondary particles as well as in the cores of secondary particles independent of their size, preferably at the expense of Mn. This feature remains in the cathode active material made from precursors made according to the present invention even after calcination. Without wishing to be bound by any theory, we assume that the above features provide excellent cycling stability.

A further aspect of the present invention relates to precursors for lithium ion batteries, hereinafter also referred to as inventive precursors. Inventive precursors are particulate transition metal (oxy)hydroxides according to general formula (II)

NiₐM¹_{b}Mn_{c}Oₓ(OH)_{y}(CO₃)ₜ (II)

where the variables are each defined as follows:
M¹ is Co or a combination of Co and at least one metal selected from Ti, Zr, Al and Mg,
a is in the range from 0.15 to 0.95, preferably 0.5 to 0.9,
b is in the range from zero to 0.35, preferably 0.03 to 0.2,
c is in the range from zero to 0.8, preferably 0.05 to 0.65,
   where a+b+c=1.0 and at least one of b and c is greater than zero,
0≤x<1, 1<y≤2.2, and 0≤t≤0.3,
   and wherein such secondary particles are agglomerated from primary particles that are essentially radially oriented.

In one embodiment of the present invention, the variables in formula (II) are defined as follows:
a is in the range of from 0.8 to 0.95,
M¹ is a combination of Co and at least one element selected from Ti, Zr, Al and Mg, with 95 mole-% up to 99.9 mole-% of M¹ being Co,
b is in the range of from 0.03 to 0.2,
c is zero,
   and a+b+c=1.0.

In another embodiment of the present invention, the variables in formula (II) are defined as follows:
a is in the range of from 0.6 to 0.95,
M¹ is Co or a combination of Co and at least one element selected from Ti, Zr, Al and Mg, with 95 mole-% up to 99.9 mole-% of M¹ being Co,
b is in the range of from 0.03 to 0.2,
c is in the range of from 0.05 to 0.2,
   and a+b+c=1.0.

In another embodiment of the present invention, the variables in formula (II) are defined as follows:
a is in the range of from 0.15 to 0.5,
b is from zero to 0.05,
c is in the range of from 0.55 to 0.8,
   and a+b+c=1.0.

The primary particles may be needle-shaped or platelets or a mixture of both. The term “radially oriented” then refers to the length in case of needle-shaped or length or breadth in case of platelets being oriented in the direction of the radius of the respective secondary particle.

The portion of radially oriented primary particles may be determined, e.g., by SEM (Scanning Electron Microscopy) of a cross-section of at least 5 secondary particles.

“Essentially radially oriented” does not require a perfect radial orientation but includes that in an SEM analysis, a deviation to a perfectly radial orientation is at most 11 degrees, preferably at most 5 degrees.

Furthermore, at least 60% of the secondary particle volume is filled with radially oriented primary particles. Preferably, only a minor inner part, for example at most 40%, preferably at most 20%, of the volume of those particles is filled with non-radially oriented primary particles, for example, in random orientation.

Inventive particulate transition metal (oxy)hydroxide has a total pore/intrusion volume in the range of from 0.033 to 0.1 ml/g, preferably 0.035 to 0.07 ml/g in the pore size range from 20 to 600 Å, determined by N₂ adsorption, determined in accordance with DIN 66134 (1998), when the sample preparation for the N₂ adsorption measurement is done by degassing at 120° C. for 60 minutes.

In a preferred embodiment, the average pore size of the inventive particulate transition metal (oxy)hydroxide is in the range of from 100 to 250 Å, determined by N₂ adsorption.

In one embodiment of the present invention, inventive particulate transition metal (oxy)hydroxide has an average secondary particle diameter D50 in the range of from 2 to 20 μm, preferably 2 to 16 μm and even more preferably 10 to 16 μm.

In one embodiment of the present invention, inventive precursors have a specific surface according to BET (hereinafter also “BET-Surface”) in the range of from 2 to 70 m²/g, preferably from 4 to 50 m²/g. The BET surface may be determined by nitrogen adsorption after outgassing of the sample at 200° C. for 30 minutes or more and beyond this accordance with DIN ISO 9277:2010.

In one embodiment of the present invention, inventive precursors have a particle size distribution [(D90)−(D10)] divided by (D50) is in the range of from 0.5 to 1.1.

Precursors obtained according to the inventive process are excellent starting materials for cathode active materials which are suitable for producing batteries with a high volumetric energy density and excellent cycling stability. Such cathode active materials are made by mixing with a source of lithium, e.g., Li₂O or LiOH or Li₂CO₃, each water-free or as hydrates, and calcination, for example at a temperature in the range of from 600 to 1000° C. A further aspect of the present invention is thus the use of inventive precursors for the manufacture of cathode active materials for lithium ion batteries, and another aspect of the present invention is a process for the manufacture of cathode active material for lithium ion batteries—hereinafter also referred to as inventive calcination—wherein said process comprises the steps of mixing a particulate transition metal (oxy)hydroxides according to any of the claims 11 to 14 with a source of lithium and thermally treating said mixture at a temperature in the range of from 600 to 1000° C. Preferably, the ratio of inventive precursor and source of lithium in such process is selected that the molar ratio of Li and TM is in the range of from 0.95:1 to 1.2:1.

Examples of inventive calcinations include heat treatment at a temperature in the range of from 600 to 900° C., preferably 650 to 850° C. The terms “treating thermally” and “heat treatment” are used interchangeably in the context of the present invention.

In one embodiment of the present invention, the mixture obtained for the inventive calcination is heated to 600 to 900° C. with a heating rate of 0.1 to 10° C./min.

In one embodiment of the present invention, the temperature is ramped up before reaching the desired temperature of from 600 to 900° C., preferably 650 to 800° C. For example, first the mixture obtained from step (d) is heated to a temperature to 350 to 550° C. and then held constant for a time of 10 min to 4 hours, and then it is raised to 650° C. up to 800° C. and then held at 650 to 800 for 10 minutes to 10 hours.

In one embodiment of the present invention, the inventive calcination is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, the inventive calcination is performed in an oxygen-containing atmosphere, for example in a nitrogen-air mixture, in a rare gas-oxygen mixture, in air, in oxygen or in oxygen-enriched air. In a preferred embodiment, the atmosphere in step (d) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen.

In one embodiment of the present invention, the inventive calcination is performed under a stream of gas, for example air, oxygen and oxygen-enriched air. Such stream of gas may be termed a forced gas flow. Such stream of gas may have a specific flow rate in the range of from 0.5 to 15 m³/h·kg material according to general formula Li₁₊ₓTM₁₋ₓO₂. The volume is determined under normal conditions: 298 Kelvin and 1 atmosphere. Said stream of gas is useful for removal of gaseous cleavage products such as water and carbon dioxide.

In one embodiment of the present invention, the inventive calcination has a duration in the range of from one hour to 30 hours. Preferred are 10 to 24 hours. The time at a temperature above 600° C. is counted, heating and holding but the cooling time is neglected in this context.

Another aspect of the present invention relates to cathode active material according to the general formula Li₁₊ₓTM₁₋ₓO₂, wherein x is in the range of from −0.05 to 0.2 and wherein TM contains metals according to formula (I)

NiₐM¹_{b}Mn_{c} (I)

where the variables are each defined as follows:
M¹ is Co or a combination of Co and at least one metal selected from Ti, Zr, Al and Mg,
a is in the range from 0.15 to 0.95,
b is in the range from zero to 0.35,
c is in the range from zero to 0.8,
   and a+b+c=1.0 and at least one of b and c is greater than zero,
   and wherein such cathode active material is composed from secondary particles wherein such secondary particles are agglomerates from primary particles and wherein at least 50 vol.-% of the secondary particles consist of agglomerated primary particles that are essentially radially oriented.

In a preferred embodiment, in inventive cathode active materials, the nickel content at the core of the secondary particles is higher than at the outer surface, preferably by 1 to 10 mole-%, and the nickel content is higher in larger secondary particles than in smaller secondary particles, preferably at the expense of Mn.

In one embodiment of the present invention, in inventive cathode active materials more than 50% of the primary particles exhibit an orientation deviating at most 11 degrees from the perfectly radial orientation, and 80% of primary particle exhibit an orientation deviating at most 34 degrees from a perfectly radial orientation.

In a preferred embodiment, in inventive cathode materials, [(D90)−(D10)] divided by (D50) of the secondary particles is in the range of from 0.4 to 2.

In a preferred embodiment, in inventive cathode materials, [(D90)−(D10)] divided by (D50) of primary particles is in the range of from 0.5 to 1.1.

In a preferred embodiment, inventive cathode active materials have a median primary axis ratio more than 1.5.

The present invention is further illustrated by two drawings and by working examples as well as further diagrams.

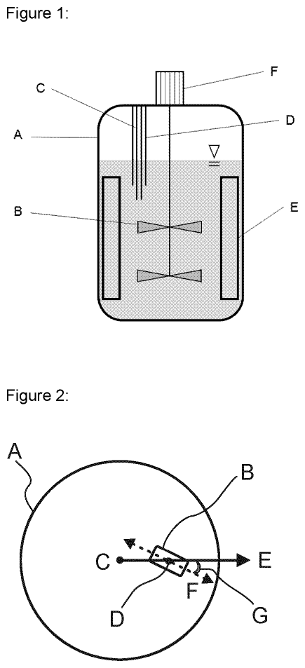

### BRIEF DESCRIPTION OF THE DRAWING, FIG. 1

A: Stirred vessel

### B: Stirrer

C: wall of inner pipe of coaxial mixer
D: wall of outer pipe of coaxial mixer

### E: Baffles

F: Engine for stirrers

### WORKING EXAMPLES

### General Remarks:

The nickel concentrations were analyzed via energy-dispersive X-Ray spectroscopy (EDS) using cross section SEM images.

The determination of the share of and extent to which primary particles are oriented radially was performed as follows:

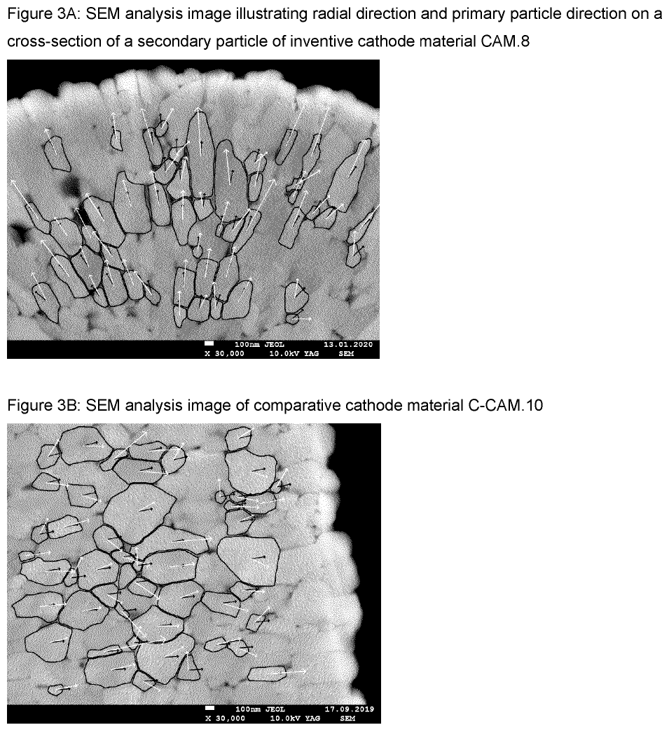

From the SEM images of cathode material cross sections, all identified primary particles were segmented for further analysis (outlined in FIG. 3) unless their surface could not be clearly identified for technical reasons. From the segmented primary particles, descriptive parameters for each particle were calculated, including primary particle size, primary particle axis ratio and primary particle orientation, as defined below.

The distributions of each of these quantities over all identified primary particles define the distribution parameters, like mean, median, standard deviation, percentiles, etc. of the respective quantity for the material.

The primary particle size was calculated as the diameter of a circle covering the identical area in the image as the particle.

The primary particle axis ratio was calculated as the particle length divided by its width, where the length and width are defined by the long and short side of the minimum bounding box of the respective particles, that is the smallest rectangle that encloses the primary particle.

Said determination method is an aspect of the present invention as well.

FIG. 2 is a diagram illustrating the radial direction. Brief description of FIG. 2 wherein the variables have the following meaning:

A: Secondary particle
B: Primary particle
C: Center of secondary particle
D: Center of primary particle
E: Radial direction, defined as the direction from secondary particle center to primary particle center
F: Primary particle orientation, defined as the orientation of the eigenvector with the largest eigenvalue of the covariance matrix calculated for the binary mask of the primary particle
G: Angle between primary particle orientation and ideal radial direction

For each primary particle, the minimum absolute angle (G) between the radial direction (E) and the direction of the primary particle major axis (F) is determined. Therefore, an angle of 0 means the primary particle is oriented towards ideal radial direction, and the larger the angle, the less ideally radially orientated. The distribution of angles G over the primary particles quantifies the extent to which the sample as a whole is radially oriented. For perfect radial orientation, the distribution will be located at zero, while for a perfect random orientation the angles will be distributed uniformly between 0 and 90 degrees with median and mean angles of 45 degrees.

FIG. 3A is an SEM analysis image illustrating radial direction and primary particle direction on a cross-section of a secondary particle of inventive cathode material CAM.8. FIG. 3B is an SEM analysis image of comparative cathode material C-CAM.10.

### I. Manufacture of Precursors

The aqueous solution of (NH₄)₂SO₄ used in the working examples contained 26.5 g (NH₄)₂SO₄ per kg solution.

Examples 1 to 4 were carried out in a 10 L stirred vessel equipped with baffles and a cross-arm stirrer with a diameter of 0.14 m and with a coaxial mixer, see FIG. 1, in the context of said working examples also referred to as “the vessel”. The coaxial mixer was located in the vessel so that the outlet of the coaxial mixer was approximately 5 cm below the liquid level. The coaxial mixer consisted of two coaxially arranged pipes made of stainless steel. The inner and outer diameter of the inner circular pipe was 3 mm and 6 mm, respectively. The inner and outer diameter of the outer circular pipe was 8 mm and 12 mm, respectively.

I.1 Manufacture of precursor TM-OH.1:

The vessel was charged with 8 liters of the above aqueous solution of (NH₄)₂SO₄. Then, the pH of the solution was adjusted to 11.5 using an 25% by weight aqueous solution of sodium hydroxide.

The temperature of the vessel was set to 45° C. The stirrer element was activated and constantly operated at 530 rpm (average input ˜6 W/l). An aqueous solution of NiSO₄, CoSO₄ and MnSO₄ (molar ratio 6:2:2, total metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 5 mm.

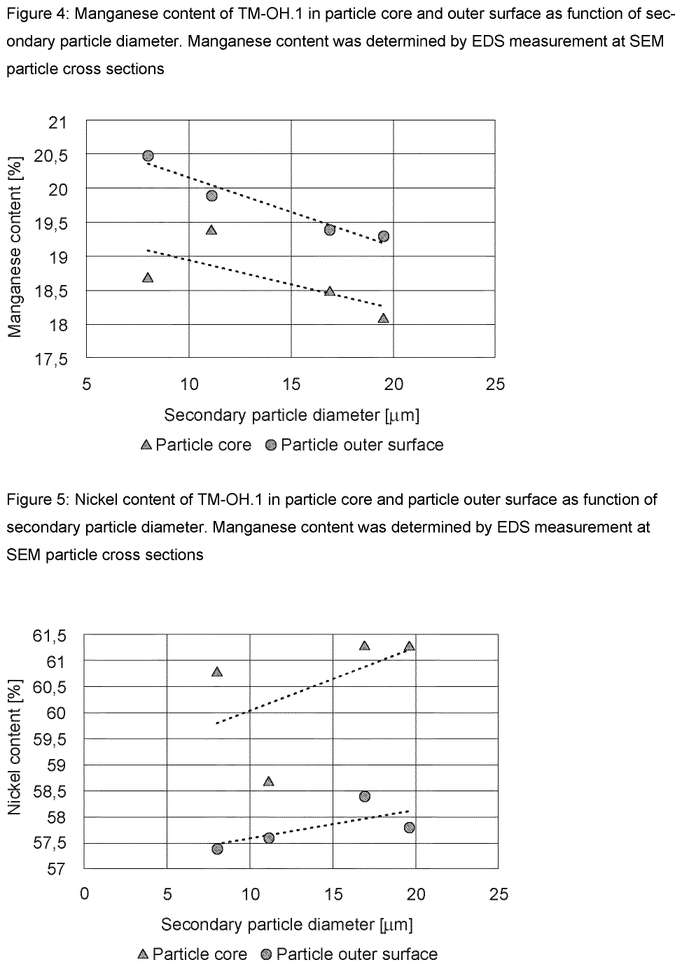

The molar ratio between ammonia and metal was adjusted to 0.3. The sum of volume flows was set to adjust the mean residence time to 6 hours. The flow rate of the NaOH was adjusted by a pH regulation circuit to keep the pH value in the stirred vessel at a constant value of 11.5. The apparatus was operated continuously keeping the liquid level in the vessel constant. A mixed hydroxide of Ni, Co and Mn was collected via free overflow from the vessel. The resulting slurry contained about 120 g/l mixed hydroxide of Ni, Co and Mn with an average particle size (D50) of 9.6 μm, TM-OH.1. The tap density and BET surface area of the inventive precursor TM-OH.1 was 1.95 g/l and 14.1 m²/g, respectively. The total pore volume and average pore size was 0.056 ml/g and 161.6 Å. At least 70% of the secondary particle volume of the inventive precursor consisted of primary particles which were essentially radially oriented. The smaller the respective secondary particles, the lower was their nickel content. Furthermore, the outer particle surfaces contained in average 4.5% less nickel than the particles cores. On the other hand, the manganese concentration was in average 5.9% higher in the outer particle surface compared to particle cores while smaller secondary particles contained more manganese than large secondary particles (see FIGS. 4 and 5). This data was generated using EDS measurements at SEM cross section micrographs.

TM-OH.1 was excellently suited as precursor for a lithium ion battery cathode active material.

FIG. 4: Manganese content of TM-OH.1 in particle core and outer surface as function of secondary particle diameter. Manganese content was determined by EDS measurement at SEM particle cross sections

FIG. 5: Nickel content of TM-OH.1 in particle core and particle outer surface as function of secondary particle diameter. Manganese content was determined by EDS measurement at SEM particle cross sections.

### I.2 Manufacture of Precursor TM-OH.2

The vessel was charged with 8 liters of the above aqueous solution of (NH₄)₂SO₄. Then, the pH of the solution was adjusted to 12.05 using an 25% by weight aqueous solution of sodium hydroxide. The temperature of the vessel was set to 45° C. The stirrer element was activated and constantly operated at 530 rpm (average input ˜6 W/l). An aqueous solution of NiSO₄, CoSO₄ and MnSO₄ (molar ratio 6:2:2, total metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 7 mm.

The molar ratio between ammonia and metal was adjusted to 0.3. The sum of volume flows was set to adjust the mean residence time to 6 hours. The flow rate of the NaOH was adjusted by a pH regulation circuit to keep the pH value in the vessel at a constant value of 12.05. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 10.5 μm, TM-OH.2. Tap density and BET surface area of precursor TM-OH.2 was 2.07 g/l and 12.48 m²/g, respectively. The total pore volume and average pore size was 0.044 ml/g and 141.5 Å. At least 70% of the secondary particle volume of TM-OH.2 consisted of primary particles which were essentially radially oriented. TM-OH.2 was excellently suited as precursor for a lithium ion battery cathode active material.

### I.3 Manufacture of Precursor TM-OH.3

The vessel was charged with 8 liters of the above aqueous solution of (NH₄)₂SO₄. Then, the pH of the solution was adjusted to 12.05 using an 25% by weight aqueous solution of sodium hydroxide.

The temperature of the vessel was set to 45° C. The stirrer element was activated and constantly operated at 530 rpm (average input ˜6 W/l). An aqueous solution of NiSO₄, CoSO₄ and MnSO₄ (molar ratio 6:2:2, total metal concentration: 1.65 mol/kg), aqueous sodium hydroxide (25 wt % NaOH) and aqueous ammonia solution (25 wt % ammonia) were simultaneously introduced through the coaxial mixer into the stirred vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 7 mm.

The molar ratio between ammonia and metal was adjusted to 0.35. The sum of volume flows was set to adjust the mean residence time to 6 hours. The flow rate of the NaOH was adjusted by a pH regulation circuit to keep the pH value in the stirred vessel at a constant value of 12.05. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 9.8 μm, TM-OH.3. The tap density and BET surface area of TM-OH.3 was 2.0 g/l and 11.3 m²/g, respectively. The total pore volume and average pore size of TM-OH.3 was 0.037 ml/g and 132.0 Å. At least 70% of the secondary particle volume of TM-OH.3 consisted of primary particles which were essentially radially oriented. TM-OH.3 was excellently suited as precursor for a lithium ion battery cathode active material.

### I.4 Manufacture of Precursor TM-OH.4

The vessel was charged with 8 liters of the above aqueous solution of (NH₄)₂SO₄. Then, the pH of the solution was adjusted to 11.5 using an 25% by weight aqueous solution of sodium hydroxide.

The temperature of the vessel was set to 55° C. The stirrer element was activated and constantly operated at 530 rpm (average input ˜6 W/l). An aqueous solution of NiSO₄, CoSO₄ and MnSO₄ (molar ratio 87:5:8, total metal concentration: 1.65 mol/kg), aqueous sodium hydroxide (25 wt % NaOH) and aqueous ammonia solution (25 wt % ammonia) were simultaneously introduced through the coaxial mixer into the stirred vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 5 mm.

The molar ratio between ammonia and metal was adjusted to 0.2. The sum of volume flows was set to adjust the mean residence time to 6 hours. The flow rate of the NaOH was adjusted by a pH regulation circuit to keep the pH value in the vessel at a constant value of 11.5. The apparatus was operated continuously keeping the liquid level in the vessel constant. A mixed hydroxide of Ni, Co and Mn was collected via free overflow from the vessel. The resulting slurry contained about 120 g/l mixed hydroxide of Ni, Co and Mn with an average particle size (D50) of 12.3 μm, TM-OH.4. The tap density and BET surface area of TM-OH.4 was 1.91 g/l and 17.94 m²/g, respectively. The total pore volume and average pore size of TM-OH.4 was 0.045 ml/g and 106.3 Å. At least 70% of the secondary particle volume of TM-OH.4 consisted of primary particles which were essentially radially oriented.

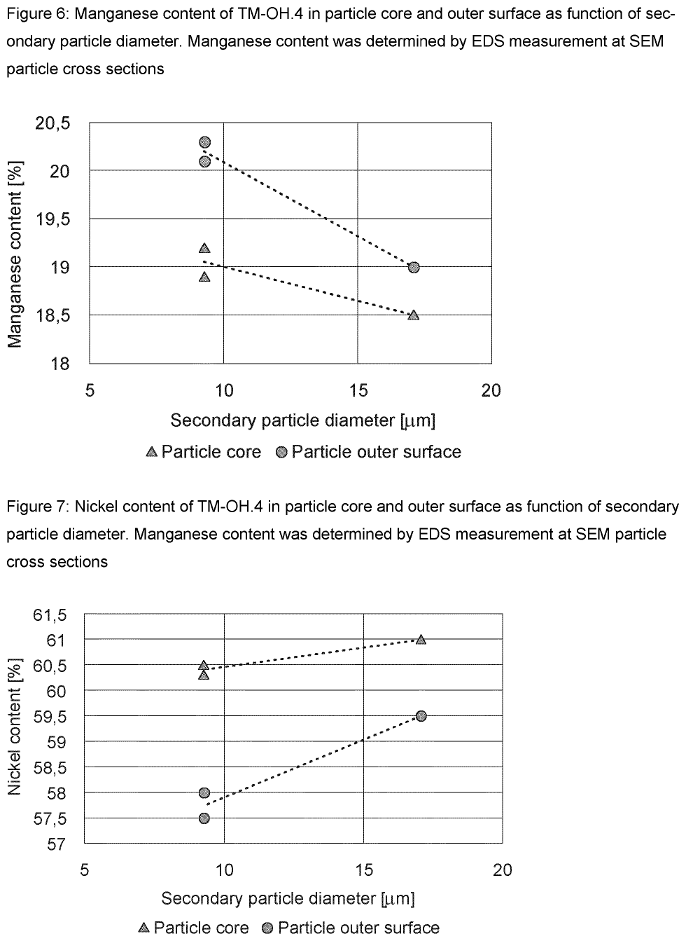

Furthermore, the outer particle surfaces of the secondary particles contained in average 3.7% less nickel than the particles cores. On the other hand, the manganese concentration was in average 4.9% higher in particle surfaces compared to particle cores while small secondary particles contained more manganese than large secondary particles (see FIGS. 6 and 7). This data was generated using EDS measurements at SEM cross section micrographs.

TM-OH.4 was excellently suited as precursor for a lithium ion battery cathode active material.

### I.5 Manufacture of Precursor TM-OH.5

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH of the solution was adjusted to 11.6 using an 25% by weight aqueous solution of sodium hydroxide. The coaxial mixer was located in the vessel so that the outlet of the coaxial mixer was approximately 10 cm below the liquid level. The coaxial mixer consisted of two coaxially arranged pipes made of stainless steel. The inner and outer diameter of the inner circular pipe was 1 mm and 4 mm, respectively. The inner and outer diameter of the outer circular pipe was 2 mm and 6 mm, respectively.

The temperature of the vessel was set to 55° C. The stirrer element was activated and constantly operated at 420 rpm (average input ˜12.6 W/l). An aqueous solution of NiSO₄, CoSO₄ and MnSO₄ (molar ratio 83:12:5, total metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 15 mm.

The molar ratio between ammonia and metal was adjusted to 0.265. The sum of volume flows was set to adjust the mean residence time to 5 hours. The flow rate of the NaOH was adjusted by a pH regulation circuit to keep the pH value in the vessel at a constant value of 11.58. The apparatus was operated continuously keeping the liquid level in the vessel constant. A mixed hydroxide of Ni, Co and Mn was collected via free overflow from the vessel. The resulting product slurry contained about 120 g/l mixed hydroxide of Ni, Co and Mn with an average particle size (D50) of 10.5 μm, TM-OH.5. The tap density and BET surface area of TM-OH.5 were 1.95 g/l and 23.1 m²/g, respectively. The total pore volume and average pore size of TM-OH.5 were 0.074 ml/g and 127.7 Å. At least 70% of the secondary particle volume TM-OH.5 consisted of primary particles which were essentially radially oriented. TM-OH.5 was excellently suited as precursor for a lithium ion battery cathode active material.

### I.6 Manufacture of Precursor TM-OH.6

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH of the solution was adjusted to 11.9 using an 25% by weight aqueous solution of sodium hydroxide. The coaxial mixer was located in the vessel so that the outlet of the coaxial mixer was approximately 10 cm below the liquid level. The coaxial mixer consisted of two coaxially arranged pipes made of stainless steel. The inner and outer diameter of the inner circular pipe was 1 mm and 4 mm, respectively. The inner and outer diameter of the outer circular pipe was 2 mm and 6 mm, respectively.

The temperature of the vessel was set to 55° C. The stirrer element was activated and constantly operated at 420 rpm (average input ˜12.6 W/l). An aqueous solution of NiSO₄, CoSO₄ and MnSO₄ (molar ratio 83:12:5, total metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 30 mm.

The molar ratio between ammonia and metal was adjusted to 0.265. The sum of volume flows was set to adjust the mean residence time to 5 hours. The flow rate of the NaOH was adjusted by a pH regulation circuit to keep the pH value in the vessel at a constant value of 11.9. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 12.3 μm, TM-OH.6. The tap density and BET surface area of TM-OH.6 were 1.93 g/l and 20.91 m²/g, respectively. The total pore volume and average pore size of TM-OH.6 were 0.066 ml/g and 126.2 Å. At least 70% of the secondary particle volume of TM-OH.6 consisted of primary particles which were essentially radially oriented. TM-OH.6 was excellently suited as precursor for a lithium ion battery cathode active material.

### I.7 Manufacture of Precursor TM-OH.7

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH of the solution was adjusted to 11.9 using an 25% by weight aqueous solution of sodium hydroxide. The coaxial mixer was located in the vessel so that the outlet of the coaxial mixer was approximately 10 cm below the liquid level. The coaxial mixer consisted of two coaxially arranged pipes made from FEP. The inner and outer diameter of the inner circular pipe was 1.5 mm and 3.2 mm, respectively. The inner and outer diameter of the outer circular pipe was 4 mm and 6 mm, respectively.

The temperature of the vessel was set to 55° C. The stirrer element was activated and constantly operated at 420 rpm (average input 12.6 W/l). An aqueous solution of NiSO₄, CoSO₄ and MnSO₄ (molar ratio 83:12:5, total transition metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 30 mm.

The molar ratio between ammonia and metal was adjusted to 0.265. The sum of volume flows was set to adjust the mean residence time to 5 hours. The flow rate of the NaOH was adjusted by a pH regulation circuit to keep the pH value in the vessel at a constant value of 11.9. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 12.3 μm, TM-OH.7. The tap density and BET surface area of TM-OH.7 were 1.93 g/l and 21.3 m²/g, respectively. The total pore volume and average pore size of TM-OH.7 were 0.066 ml/g and 126.2 Å. At least 70% of the secondary particle volume of TM-OH.7 consisted of primary particles which were essentially radially oriented. TM-OH.7 was excellently suited as precursor for a lithium ion battery cathode active material.

### I.8 Manufacture of Precursor TM-OH.8

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH of the solution was adjusted to 11.88 using an 25% by weight aqueous solution of sodium hydroxide. The coaxial mixer was located in the vessel so that the outlet of the coaxial mixer was approximately 10 cm below the liquid level. The coaxial mixer consisted of two coaxially arranged pipes made of FEP. The inner and outer diameter of the inner circular pipe was 1.5 mm and 3.2 mm, respectively. The inner and outer diameter of the outer circular pipe was 4 mm and 6 mm, respectively.

The temperature of the vessel was set to 55° C. The stirrer element was activated and constantly operated at 420 rpm (average input ˜12.6 W/l). An aqueous solution of NiSO₄, CoSO₄ and MnSO₄ (molar ratio 83:12:5, total metal concentration: 1.65 mol/kg), aqueous sodium hydroxide (25 wt % NaOH) and aqueous ammonia solution (25 wt % ammonia) were simultaneously introduced through the coaxial mixer into the vessel. The aqueous metal solution was introduced via the inner pipe of the coaxial mixer while the aqueous sodium hydroxide and aqueous ammonia solution were introduced via the outer pipe of the coaxial mixer. The distance between the outlets of the two coaxially arranged pipes was in the range of 30 mm.

The molar ratio between ammonia and metal was adjusted to 0.265. The sum of volume flows was set to adjust the mean residence time to 5 hours. The flow rate of the NaOH was adjusted by a pH regulation circuit to keep the pH value in the vessel at a constant value of 11.9. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 12.0 μm, TM-OH.8. The tap density and BET surface area of TM-OH.8 were 1.92 g/l and 20.58 m²/g, respectively. At least 70% of the secondary particle volume of TM-OH.8 consisted of primary particles which were essentially radially oriented. TM-OH.8 was excellently suited as precursor for a lithium ion battery cathode active material.

### I.9 Comparative Example—Manufacture of a Comparative Precursor C-TM-OH.9

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH value of the solution was adjusted to 11.4 using an 25% by weight aqueous solution of sodium hydroxide. In this experiment, feeds were not added through a coaxial mixer. Instead, the transition metal feed was dosed via a dipped pipe with inner diameter of 4 mm close to stirrer element while NaOH and ammonia were dosed via a separate dipped pipe with inner diameter of 4 mm close to the stirrer element. The outlets of both pipes had a distance larger than 10 times of the inner hydraulic diameter of alkali dosing pipe.

The temperature of the vessel was set to 55° C. The stirrer element was activated and constantly operated at 420 rpm (average input 12.6 W/l). An aqueous solution of NiSO₄, CoSO₄ and MnSO₄ (molar ratio 83:12:5, total metal concentration: 1.65 mol/kg), aqueous sodium hydroxide (25 wt % NaOH) and aqueous ammonia solution (25 wt % ammonia) were introduced simultaneously.

The molar ratio between ammonia and transition metal was adjusted to 0.115. The sum of volume flows was set to adjust the mean residence time to 5 hours. The flow rate of the NaOH was adjusted by a pH regulation circuit to keep the pH value in the vessel at a constant value of 11.4. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 10.2 μm, C-TM-OH.9. C-TM-OH.9 was used as precursor for a comparative lithium ion battery cathode active material.

### I.10 Comparative Example—Manufacture of a Comparative Precursor C-TM-OH.10

A 50 L stirred vessel equipped with baffles and a cross-arm stirrer with a diameter of 0.21 m and a coaxial mixer, see FIG. 1, was charged with 40 liters of the above aqueous solution of (NH₄)₂SO₄. Then, the pH of the solution was adjusted to 12.34 using an 25% by weight aqueous solution of sodium hydroxide. In this experiment, feeds were not dosed by coaxial mixer. Instead, the transition metal feed was dosed via a dipped pipe with inner diameter of 4 mm close to stirrer element while NaOH and ammonia were dosed via a separate dipped pipe with inner diameter of 4 mm close to stirrer element. The outlets of both pipes had a distance larger than 10 times of the inner hydraulic diameter of alkali dosing pipe.

The temperature of the vessel was set to 55° C. The stirrer element was activated and constantly operated at 420 rpm (average input ˜12.6 W/l). An aqueous metal solution containing NiSO₄, CoSO₄ and MnSO₄ (molar ratio 87:5:8, total metal concentration: 1.65 mol/kg), aqueous sodium hydroxide (25 wt % NaOH) and aqueous ammonia solution (25 wt % ammonia) were introduced simultaneously.

The molar ratio between ammonia and metal was adjusted to 0.4. The sum of volume flows was set to adjust the mean residence time to 5 hours. The flow rate of the NaOH was adjusted by a pH regulation circuit to keep the pH value in the vessel at a constant value of 12.34. The apparatus was operated continuously keeping the liquid level in the reaction vessel constant. A mixed hydroxide of Ni, Co and Mn was collected via free overflow from the vessel. The resulting slurry contained about 120 g/l mixed hydroxide of Ni, Co and Mn with an average particle size (D50) of 13.0 μm, C-TM-OH.10. C-TM-OH.10 was used as precursor for a comparative lithium ion battery cathode active material.

### II. Manufacture of Inventive Cathode Active Materials

II.1 Manufacture of Inventive Cathode Material CAM.1 Made from TM-OH.1

The precursor TM-OH.1 was mixed with LiOH monohydrate and crystalline Al₂O₃ in a concentration of 0.3 mole-% Al relative to Ni+Co+Mn+Al and a Li/(Ni+Co+Mn+Al) molar ratio of 1.02. The resultant mixture was heated to 820° C. and kept for 8 h in a forced flow of oxygen. After natural cooling the obtained calcined powder was de-agglomerated and sieved through a 32 μm vibrational screen. Cathode active material CAM.1 was obtained.

The 0.1C first discharge of CAM.1, measured in half-cell, amounted 187.0 mAh/g. The capacity after 100 cycles in half-cell amounted 99.8%, respectively.

11.2 Manufacture of inventive cathode material CAM.4 made from TM-OH.4 The precursor TM-OH.4 was mixed with LiOH monohydrate and crystalline Al₂O₃ in a concentration of 0.3 mole-% Al relative to Ni+Co+Mn+Al and a Li/(Ni+Co+Mn+Al) molar ratio of 1.02. The resultant mixture was heated to 820° C. and kept for 5 h in a forced flow of oxygen. After natural cooling the obtained calcined powder was de-agglomerated and sieved through a 32 μm vibrational screen. Cathode active material CAM.4 was obtained.

The 0.1C first discharge of CAM.4, measured in half-cell, amounted 186.0 mAh/g. The capacity after 100 cycles in half-cell amounted 98.5%, respectively.

II.3 Manufacture of Inventive Cathode Material CAM.5 Made from TM-OH.5

The precursor TM-OH.5 was mixed with LiOH monohydrate in a Li/(Ni+Co+Mn) molar ratio of 1.02. The resultant mixture was heated to 760° C. and kept for 6 h in a forced flow of oxygen. After natural cooling the obtained calcined powder was deagglomerated and sieved through a 32 μm vibrational screen. Cathode active material CAM.5 was obtained.

The median primary particle diameter is 0.24 μm with a span of 0.92 and a median axis ratio of 1.88.

The orientation of 20% of the primary particles of CAM.5 deviated 2.8 degrees or less from the ideal radial orientation, 50% deviated 10.5 degrees or less, and even 80% deviated or less. An exemplary micrograph of SEM cross section of inventive CAM.5 is shown in FIG. 3B.

The 0.1C first discharge of CAM.5, measured in half-cell, amounted to 205.8 mAh/g. The capacity after 50 and 100 1C cycles in full-cell amounted to 97.9% and 90.6%, respectively.

II.4 Manufacture of Inventive Cathode Material CAM.8 Made from TM-OH.8

The precursor TM-OH.8 was mixed with LiOH monohydrate as well as with TiO₂ and Zr(OH)₄ with concentrations of 0.17 mole-% Zr and 0.17 mole % Ti relative to Ni+Co+Mn+Zr+Ti and a Li/(Ni+Co+Mn+Zr+Ti) molar ratio of 1.05. The mixture was heated to 780° C. and kept for 6 h in a forced flow of oxygen. After natural cooling the obtained calcined powder was deagglomerated and sieved through a 32 μm vibrational screen. Cathode active material CAM.8 was obtained.

The median primary particle diameter was 0.37 μm with a span of 1.10 and a median axis ratio of 1.56. The orientation of 20% of primary particles deviated 4.3 degrees or less from the ideal radial orientation, 50% deviated 10.7 degrees or less, and even 80% deviated 31.0 degrees or less.

The 0.1C first discharge of CAM.8, measured in half-cell, amounted 204.7 mAh/g. The capacity after 50 and 100 1C cycles in full-cell amounted 96.3% and 94.1%, respectively.

II.5 Comparative Example—Manufacture of Cathode Material C-CAM.10 Made from C-TMOH.10

The precursor TM-OH.10 was mixed with LiOH monohydrate as well as with TiO₂ and a Zr(OH)₄ with concentrations of 0.17 mole-% Zr and 0.17 mole % Ti relative to Ni+Co+Mn+Zr+Ti and a Li/(Ni+Co+Mn+Zr+Ti) molar ratio of 1.04. The resultant mixture was heated to 760° C. and kept for 5 h in a forced flow of oxygen. After natural cooling the obtained calcined powder was deagglomerated and sieved through a 32 μm vibrational screen. Cathode active material C-CAM.10 was obtained.

The median primary particle diameter was 0.27 μm with a span of 1.27 and a median axis ratio of 1.44. An exemplified micrograph of SEM cross section of comparative cathode active material C-CAM.10 is shown in FIG. 3A.

The orientation of 20% of primary particles deviated 9.0 degrees or less from the ideal radial orientation, 50% deviated 20.3 degrees or less, and 80% deviate 45.0 degrees or less. The 0.1C first discharge of C-CAM.10, measured in half-cell, amounted to 203.7 mAh/g. The capacity after 50 and 100 1C cycles in full-cell amounted to 94.2% and 86.5%, respectively.

### III. Electrochemical Tests

Percentages are—unless specified otherwise—weight percent. In case of cathodes, the percentages refer to the entire cathode minus the current collector.

### III.1 Cathode Manufacture

Electrode manufacture: Electrodes contained 93% of the respective cathode active material, 1.5% carbon black (Super C65), 2.5% graphite (SFG6 L) and 3% binder (polyvinylidene fluoride, Solef 5130). Slurries were mixed in N-methyl-2-pyrrolidone and cast onto aluminum foil by doctor blade. After drying of the electrodes 6 h at 105° C. in vacuo, circular electrodes were punched, weighed and dried at 120° C. under vacuum overnight before entering in an Ar filled glove box.

### III.2 Electrolyte

Electrolyte 1: 1 M LiPF₆ in ethylene carbonate (EC): dimethyl carbonate (DMC), 1:1 by weight, was used as the electrolyte.

Electrolyte 2: 1 M LiPF₆ in EC: ethyl methyl carbonate (EMC), 1:1 by weight, containing 2 wt-% vinylene carbonate

### III.3 Anode

A 0.58 mm thick Li foil

### III.3 Manufacture of Half-Cell Type Coin Cells

Coin-type electrochemical cells were assembled in an argon-filled glovebox. The positive 14 mm diameter (loading 11.0·0.4 mg cm⁻²) electrode was separated from the anode by a glass fiber separator (Whatman GF/D). An amount of 100 μl of electrolyte 1 was used for the half cells.

A Maccor 4000 system was used for testing. The cells were galvanostaticylly cycled between 3 and 4.3V vs Li and then potentiostatically at 4.3V for 30 min or until the current was below the 0.01C current. The cells were placed in the Binder climate chambers at a defined temperature of 25° C. The cell were cycled for 129 cycles, first at the 0.1C/0.1C (charge/discharge, hereafter) rate for 2 cycles for the capacity determination; then at the 0.1C/0.1C rate for 5 cycles for conditioning; then at the 0.5C/0.1C, 0.5C/0.2C, 0.5C/0.5C, 0.5C/1C, 0.5C/2C, 0.5C/3C, rate for 6 cycles for the discharge rate capability determination; then at the 0.5C/0.1C rate for 2 cycles for the capacity determination; then at the 0.5C/0.1C rate for 50 cycles for the cycling stability determination; then at the 0.5C/0.1C rate for 2 cycles for the capacity determination; then at the 0.5C/0.1C rate for 50 cycles for the cycling stability determination; then at the 0.5C/0.1C rate for 2 cycles for the capacity determination and finally at the 0.5C/0.1C rate for 10 cycles for the cycling stability determination.

### III.4 Manufacture of Full-Cell Type Coin Cells

Full-Cell Electrochemical Measurements: Coin-type electrochemical cells were assembled in an argon-filled glovebox. The positive 17.5 mm diameter (loading: 11.3.1.1 mg cm⁻²) electrode was separated from the 18.5 mm graphite anode by a glass fiber separator (Whatman GF/D). An amount of 300 μl of was electrolyte 2. Cells were galvanostatically cycled be-tween 2.7 and 4.20 V at a the 1C rate and 45° C. with a potentiostatic charge step at 4.2 V for 1 h or until the current drops below 0.02C using a Maccor 4000 battery cycler.

During the resistance measurement (conducted every 25 cycles at 25° C.), the cell was charged in the same manner as for cycling. Then, the cell was discharged for 30 min at 1 C to reach 50% state of charge. To equilibrate the cell, a 30 s open circuit step followed. Finally, a 2.5 C discharge current was applied for 30 s to measure the resistance. At the end of the current pulse, the cell was again equilibrated for 30 s in open circuit and further discharged at 1 C to 2.7 V vs. graphite.

To calculate the resistance, the voltage before applying the 2.5 C pulse current, VOs, and after 10 s of 2.5 C pulse current, V10 s, as well as the 2.5 C current value, (I in A), were taken. The resistance was calculated according to Eq. 1 (S: electrode area, V: voltage, I: 2.5C pulse current).

R=(V0s−V10s)/I*S (Eq. 1)

1. A process for precipitating a mixed hydroxide of TM, wherein TM comprises Ni and at least one of Co and Mn and, optionally, Al, Mg, Zr or Ti, from an aqueous solution of salts of such transition metals or of Al or of Mg, wherein such process is carried out in a stirred vessel and comprises: introducing an aqueous solution of alkali metal hydroxide and an aqueous solution of transition metal salts through at least two inlets into the stirred vessel, wherein a distance of the locations of introducing the salts of TM and of alkali metal hydroxide is equal or less than 6 times a hydraulic diameter of a tip of the inlet of the alkali metal hydroxide.

2. The process according to claim 1, wherein the at least two inlets are designed as a coaxial mixer and the coaxial mixer comprises two coaxially arranged pipes through which an aqueous solution of alkali metal hydroxide and an aqueous solution of salts of TM are introduced into the stirred vessel.

3. The process according to claim 1, wherein the locations of introducing the aqueous solutions of metal salts and of alkali metal hydroxide are below the level of liquid in the stirred vessel.

4. The process according to claim 1, wherein the locations of introducing the aqueous solutions of metal salts and of alkali metal hydroxide are above the level of liquid in the stirred vessel.

5. The process according to any of claim 2, wherein the solution of metal salts is introduced through an inner pipe of the coaxial mixer and the solution of alkali metal hydroxide is introduced through an outer pipe.

6. The process according to claim 1, wherein the aqueous solution of alkali metal hydroxide contains comprises ammonia.

7. The process according to claim 1, wherein the stirred vessel is a continuous stirred tank reactor.

8. The process according to claim 1, wherein the at least two inlets are designed as a coaxial mixer and wherein in an interval, the coaxial mixer is flushed with water to remove transition metal (oxy)hydroxide incrustations.

9. The process according to claim 1, wherein a velocity for introducing aqueous solution of alkali metal hydroxide and aqueous solution of transition metal salts ranges from 0.01 to 10 m/s.

10. The process according to claim 1, wherein TM comprises metals according to formula (I)
NiₐM¹_{b}Mn_{c} (I)
wherein
M¹ is Co or a combination of Co and at least one metal chosen from Ti, Zr, Al and Mg,
a ranges from 0.15 to 0.95,
b ranges from zero to 0.35,
c ranges from zero to 0.8,
and a+b+c=1.0 and at least one of b and c is greater than zero.

11. A particulate transition metal (oxy)hydroxide according to general formula (II)
NiₐM¹_{b}Mn_{c}Oₓ(OH)_{y}(CO₃)ₜ (II)
wherein
M¹ is Co or a combination of Co and at least one metal chosen from Ti, Zr, Al and Mg,
a ranges from 0.15 to 0.95,
b ranges from zero to 0.35,
c ranges from zero to 0.8,
where a+b+c=1.0 and at least one of b and c is greater than zero,
0≤x<1, 1<y≤2.2, and 0≤t≤0.3,
wherein at least 60 vol.-% of secondary particles consist of agglomerated primary particles that are radially oriented or deviated to a perfectly radial orientation of at most 11 degrees in an SEM analysis, and
wherein the particulate transition metal has a total pore/intrusion volume ranging from 0.033 ml/g to 0.1 ml/g, determined by N₂ adsorption.

12. The particulate transition metal (oxy)hydroxide according to claim 11, wherein
a ranges from 0.3 to 0.9,
b ranges from zero to 0.2, and
c ranges from 0.05 to 0.7.

13. The particulate transition metal (oxy)hydroxide according to claim 11, wherein the particulate transitional metal (oxy)hydroxide has having a specific surface according to BET ranging from 2 m²/g to 70 m²/g.

14. The particulate transition metal (oxy)hydroxide according to claim 11, wherein the particle size distribution [(D90)−(D10)] divided by (D50) ranges from 0.5 to 2.

15. The particulate transition metal (oxy)hydroxide according to 11 wherein the nickel content at the core of the particles is higher than at the outer surface of the secondary particles.

16. (canceled)

17. A process for manufacture of an electrode active material for lithium ion batteries, wherein the process comprises:
mixing a particulate transition metal (oxy)hydroxides according to claim 11 with a source of lithium and
thermally treating the mixture at a temperature ranging from 600° C. to 1000° C.

18. A cathode active material according to general formula Li₁₊ₓTM₁₋ₓO₂, wherein x ranges from −0.05 to 0.2 and wherein TM comprises metals according to formula (I)
NiₐM¹_{b}Mn_{c} (I)
wherein
M¹ is Co or a combination of Co and at least one metal chosen from Ti, Zr, Al and Mg,
a ranges from 0.15 to 0.95,
b ranges from zero to 0.35,
c ranges from zero to 0.8, and a+b+c=1.0 and at least one of b and c is greater than zero, and
wherein such cathode active material is composed from secondary particles wherein the secondary particles are agglomerates from primary particles and wherein at least 50 vol.-% of the secondary particles consist of agglomerated primary particles radially oriented or deviated to a perfectly radial orientation of at most 11 degrees in an SEM analysis.

19. The cathode active material according to claim 18, wherein the nickel content at the core of the particles is higher than at the outer surface of the secondary particles.

20. The cathode active material according to claim 18, wherein more than 50% of the primary particles exhibit an orientation deviating at most 11 degrees from the perfectly radial orientation, and 80% of primary particle exhibit an orientation deviating at most 34 degrees from a perfectly radial orientation.

21. The cathode active material according to any of claim 18, wherein the primary particle size distribution has a span [(D90)−(D10)] divided by (D50), ranging from 0.5 to 1.1.

22. The cathode active material according to claim 18, wherein the primary particles have a median primary axis ratio of more than 1.5.
